(19) United States
(12) Patent Application Publication
(10) Pub. No.: US 2010/0123736 A1
(43) Pub. Date: May 20, 2010

(54) Information processing apparatus, image display method and computer program

(75) Inventor: Hitoshi Fukudome, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/589,567

(22) Filed: Oct. 23, 2009

(30) Foreign Application Priority Data
Nov. 14, 2008 (JP) P2008-291973

(51) Int. Cl. G09G 5/00

(52) U.S. Cl. 345/649; 345/619; 345/660

(57) ABSTRACT

There is provided an information processing apparatus, including a storage unit for storing content identification information for identifying a content, content analysis result corresponding to the content identification information and being obtained by analyzing the content, and a first image corresponding to the content identification information, a coordinate specifying unit for specifying a predetermined coordinate in a three-dimensional coordinate system, and a display control unit for arranging the first image corresponding to the content identification information or a second image different from the first image on the three-dimensional coordinate system based on the content analysis result stored in the storage unit, and displaying the first image and/or the second image according to a distance with a coordinate corresponding to the content identification information based on the predetermined coordinate specified by the coordinate specifying unit and the content analysis result.

### BACKGROUND OF THE INVENTION

1. Field of the Invention

The present invention relates to an information processing apparatus, an image display method, and a computer program.

2. Description of the Related Art

Text files, video files, music files and the like recorded in an information processing apparatus such as a personal computer have been often organized and saved in hierarchical structure by the user of the information processing apparatus to facilitate classification. For instance, a folder for storing text files, a folder for storing video files, a folder for storing music files, and the like have been prepared, and a folder is further created in such folders so as to have a hierarchical structure, so that data management can be facilitated by storing the files in the created folders.

When reproducing the files recorded with music and video (hereinafter also collectively referred to as “content”) organized and saved in hierarchical structure, an application of so-called juke box program is often used (see e.g., Japanese Patent Application Laid-Open No. 2000-207415). In the juke box program, the content are displayed in a list on a screen, where the content may be displayed by type of content (e.g., by music or by video) or the content narrowed down to content belonging to a specific artist or album, or genre may be displayed.

Recently, a content exchanging system of connecting a small portable terminal to the information processing apparatus and exchanging content between the portable terminal and the information processing apparatus has been widespread used. The content are exchanged using the juke box program in such content exchanging system, where not only the content saved in the information processing apparatus, but also the content saved in the portable terminal can be displayed with the juke box program, and content can be newly transferred to the portable terminal or content saved in the portable terminal can be deleted using the juke box program.

### SUMMARY OF THE INVENTION

With increase in capacity of the hard disc built in the personal computer, an enormous number of content can be managed in the personal computer. When searching and selecting the content the user desires to listen to or the music to be transferred to the portal telephone, the portable music reproducing device, the portable game machine, and other portable terminals from the content, a general method is to search for the metadata attached to the music such as artist name, album name, and song title by text.

However, this method has an issue in that it depends on the name in the memory of the user, and the target content may not be reliably searched if the memory of the user is wrong or unclear.

Furthermore, the method of searching for the target music from the vibe of the song includes a method of searching with cheerful song/depressing song, up-tempo song/slow song, and the like using the metadata obtained by a music analyzing technique such as 12 tone analyzing technique. Since information obtained as a result of the 12 tone analyzing technique is added as an absolute value, the target music is difficult to search unless the music possessed by the user has numerous variations. Furthermore, when searching from the vibe, the interpretation of the vibe differs among individuals even if the vibe is expressed in text data and the search is difficult unless the operation is experienced repeatedly.

In light of the foregoing, it is desirable to provide a novel and improved information processing apparatus, image display method, and computer program capable of facilitating the search and the selection of the content without relying on the experience of the user by displaying an image corresponding to each content on a three-dimensional coordinate system using the analysis result of the content.

According to an embodiment of the present invention, there is provided an information processing apparatus, including a storage unit for storing content identification information for identifying a content, content analysis result corresponding to the content identification information and being obtained by analyzing the content, and a first image corresponding to the content identification information, a coordinate specifying unit for specifying a predetermined coordinate in a three-dimensional coordinate system, and a display control unit for arranging the first image corresponding to the content identification information or a second image different from the first image on the three-dimensional coordinate system based on the content analysis result stored in the storage unit, and displaying the first image and/or the second image according to a distance with a coordinate corresponding to the content identification information based on the predetermined coordinate specified by the coordinate specifying unit and the content analysis result.

According to such configuration, a storage unit stores content identification information for identifying a content, content analysis result corresponding to the content identification information and being obtained by analyzing the content, and a first image corresponding to the content identification information. A coordinate specifying unit specifies a predetermined coordinate of a three-dimensional coordinate system displayed on the display unit according to the operation input. The display control unit arranges the first image corresponding to the content identification information or a second image different from the first image on the three-dimensional coordinate system based on the content analysis result stored in the storage unit, and displays the first image and/or the second image according to a distance with a coordinate corresponding to the content identification information based on the predetermined coordinate specified by the coordinate specifying unit and the content analysis result. As a result, the search and the selection of the content can be facilitated without relying on the experience of the user by displaying an image corresponding to each content on the three-dimensional coordinate system using the analysis result of the content.

The display control unit may display information of a content contained in the content identification information when the first image or the second image is selected by the operation input.

The information processing apparatus may further include a content reproduction unit for reproducing content corresponding to the first image or the second image when the first image or the second image is selected by the operation input.

The display control unit does not display the first image for the content positioned at less than a predetermined distance from the predetermined coordinate specified by the coordinate specifying unit.

The display control unit may display the second image from a point spaced apart by greater than or equal to a predetermined distance from the predetermined coordinate specified by the coordinate specifying unit.

The display control unit may display while changing the size of the first image and the second image according to a distance on the three-dimensional coordinate system from a predetermined position.

When the operation input may be a process of rotating the three-dimensional coordinate system, the display control unit may change display of the first image and the second image according to the process.

When the operation input is a process of enlarging or reducing with respect to the display of the three-dimensional coordinate system, the display control unit may change display of the first image and the second image according to the process.

The information processing apparatus may further include a coordinate axis specifying unit for specifying a coordinate axis of the three-dimensional coordinate system with an arbitrary content analysis result. The display control unit may display the first image and/or the second image based on a coordinate axis specified by the coordinate axis specifying unit.

The information processing apparatus may further include a content selecting unit for selecting one or more contents by including the first image and the second image inside a sphere formed by specifying an arbitrary radius with an arbitrary position as a center.

According to another embodiment of the present invention, there is provided an image display method including the steps of storing content identification information for identifying a content, content analysis result corresponding to the content identification information and being obtained by analyzing the content, and a first image corresponding to the content identification information, specifying a predetermined coordinate in a three-dimensional coordinate system, and arranging the first image corresponding to the content identification information or a second image different from the first image on the three-dimensional coordinate system based on the content analysis result stored in the storing means, and displaying the first image and/or the second image according to a distance with a coordinate corresponding to the content identification information based on the predetermined coordinate specified by the coordinate specifying unit and the content analysis result.

According to another embodiment of the present invention, there is provided a computer program for causing a computer to execute the steps of storing content identification information for identifying a content, content analysis result corresponding to the content identification information and being obtained by analyzing the content, and a first image corresponding to the content identification information, specifying a predetermined coordinate in a three-dimensional coordinate system, and arranging the first image corresponding to the content identification information or a second image different from the first image on the three-dimensional coordinate system based on the content analysis result stored in the storing means, and displaying the first image and/or the second image according to a distance with a coordinate corresponding to the content identification information based on the predetermined coordinate specified by the coordinate specifying unit and the content analysis result.

As described above, according to the present invention, there can be provided a novel and improved information processing apparatus, an image display method, and a computer program capable of facilitating the search and the selection of the content by displaying an image corresponding to each content on the three-dimensional coordinate system using the analysis result of the content.

### BRIEF DESCRIPTION OF THE DRAWINGS

FIG. 1 is an explanatory view showing an information processing apparatus 100 according to one embodiment of the present invention and a configuration of a content exchanging system 10 using the information processing apparatus 100;

FIG. 2 is an explanatory view describing a hardware configuration of the information processing apparatus 100 according to one embodiment of the present invention;

FIG. 3 is an explanatory view describing the functional configuration of the information processing apparatus 100 according to one embodiment of the present invention;

FIG. 4 is an explanatory view showing an example of an image displayed on a display unit 112 by a display control unit 128;

FIG. 5 is an explanatory view showing an example of an image displayed on a display unit 112 by a display control unit 128;

FIG. 6 is an explanatory view showing an example of an image displayed on a display unit 112 by a display control unit 128;

FIG. 7 is an explanatory view showing an example of an image displayed on a display unit 112 by a display control unit 128;

FIG. 8 is an explanatory view describing the display control of the jacket image;

FIG. 9 is an explanatory view showing a case of rotating the image of the three-dimensional space system by the operation of the user;

FIG. 10A is an explanatory view showing an overview of a case of controlling the jacket image corresponding to the content to be in non-display near the coordinate corresponding to the view point;

FIG. 10B is an explanatory view showing an overview of a case of controlling the jacket image corresponding to the content to be in non-display near the coordinate corresponding to the view point;

FIG. 11A is an explanatory view for when selecting the content by an object appearing in spherical shape;

FIG. 11B is an explanatory view for when selecting the content by an object appearing in spherical shape; and

FIG. 12 is an explanatory view showing an application example of the image displayed by the display control unit 128 according to one embodiment of the present invention to the juke box program.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present invention will be described in detail below according to the following order.

One embodiment of the present invention
[1] Content exchanging system using information processing apparatus
[2] Hardware configuration of information processing apparatus
[3] Functional configuration of information processing apparatus
[4] Summary

### ONE EMBODIMENT OF THE PRESENT INVENTION

### [1] Content Exchanging System Using Information Processing Apparatus

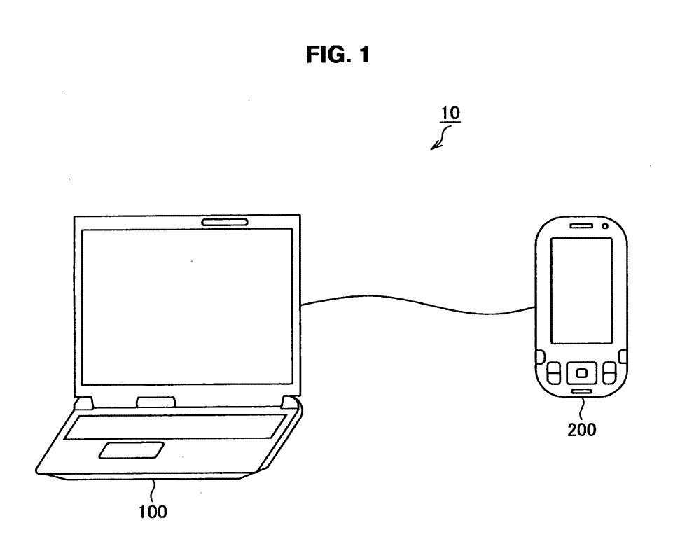

First, the configuration of a content exchanging system using an information processing apparatus according to one embodiment of the present invention will be described. FIG. 1 is an explanatory view showing an information processing apparatus 100 according to one embodiment of the present invention and a configuration of a content exchanging system 10 using the information processing apparatus 100. The information processing apparatus 100 according to one embodiment of the present invention and the configuration of the content exchanging system 10 using the information processing apparatus 100 will be described using FIG. 1.

As shown in FIG. 1, the content exchanging system 10 according to one embodiment of the present invention is configured to include the information processing apparatus 100 and a portable terminal 200. The content exchanging system 10 shown in FIG. 1 exchanges content between the information processing apparatus 100 and the portable terminal 200. For instance, the system can transfer the music retrieved from a compact disc (CD) to the information processing apparatus 100 to the portable terminal 200, or back up the music downloaded to the portable terminal 200 through a communication network from a server such as a music distributer in the information processing apparatus 100. The information processing apparatus 100 and the portable terminal 200 can be connected with the USB (Universal Serial Bus) cable, cable complying with IEEE 1394, and the like.

The information processing apparatus 100 is a device that interiorly stores various types of information and uses the same such as a personal computer (PC). In the present embodiment, the content is exchanged between the information processing apparatus 100 and the portable terminal 200, and the content stored in the portable terminal 200 is managed (e.g., edit, deletion of content) from the information processing apparatus 100. The internal configuration of the information processing apparatus 100 will be hereinafter described in detail.

The portable terminal 200 is a small terminal for carrying around such as portable telephone, portable game machine, and portable music reproducing device. In the present embodiment, the portable telephone will be described, by way of example, as the portable terminal 200.

In such content exchanging system 10, the content can be transferred from the information processing apparatus 100 to the portable terminal 200 by selecting the content to transfer to the portable terminal 200 from the content saved in the information processing apparatus 100.

However, the number of contents that can be stored in the information processing apparatus 100 becomes enormous with increase in the storage capacity of the information processing apparatus 100, and it may become difficult to search for the content to transfer. In particular, with increase in the storage capacity of the information processing apparatus 100, if the content which detailed information such as song title and singer name are unknown is stored in the information processing apparatus 100, such content becomes very difficult to search by relying on the memory of the user.

In one embodiment of the present invention, the information processing apparatus 100 that arranges an image showing contents on a screen based on the analysis result of the contents will be described. The easiness in searching the content, and new discovery of the content can be provided by arranging the image showing contents on the screen based on the analysis result of the contents.

The information processing apparatus 100 according to one embodiment of the present invention and the configuration of the content exchanging system 10 using the information processing apparatus 100 has been described above. The configuration of the information processing apparatus 100 according to one embodiment of the present invention will now be described.

### [2] Hardware Configuration of Information Processing Apparatus

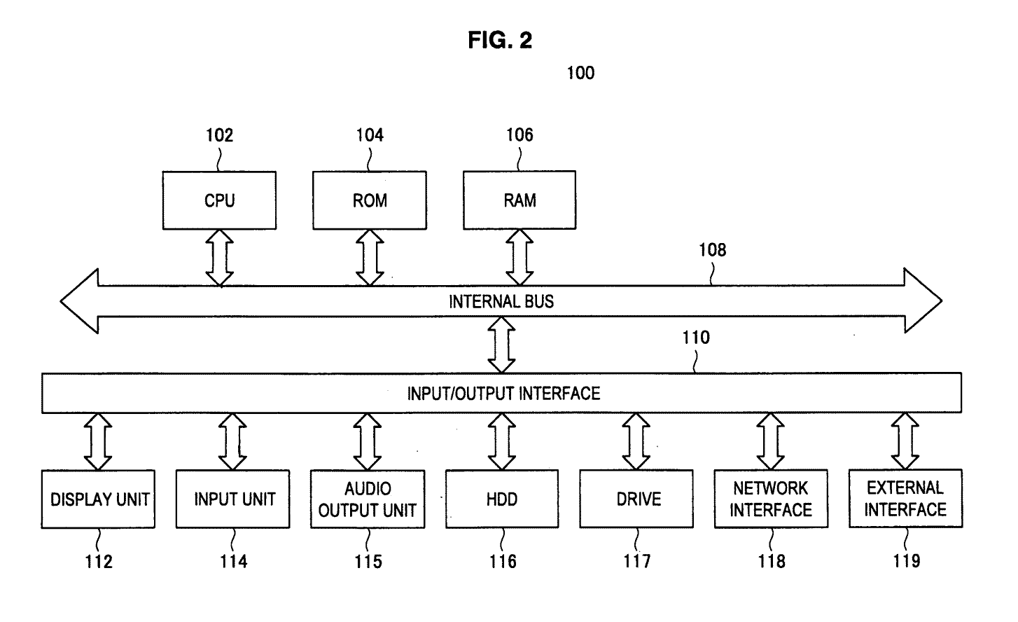

FIG. 2 is an explanatory view describing a hardware configuration of the information processing apparatus 100 according to one embodiment of the present invention. The hardware configuration of the information processing apparatus 100 according to one embodiment of the present invention will be described below using FIG. 2.

As shown in FIG. 2, the information processing apparatus 100 according to one embodiment of the present invention is configured to include a CPU (Central Processing Unit) 102, a ROM (Read Only Memory) 104, a RAM (Random Access Memory) 106, an internal bus 108, an input/output interface 110, a display unit 112, an input unit 114, an audio output unit 115, an HDD (Hard Disk Drive) 116, a drive 117, a network interface 118, and an external interface 119.

The CPU 102 performs numerical calculation and information processing, device control, and the like, and performs the numerical calculation and information processing, and the device control by sequentially reading out programs stored in the ROM 104 and data stored in the RAM 106 and based on a signal corresponding to a command input from the input unit 114 by the user of the information processing apparatus 100 and a signal transmitted from an external device via the network interface 118.

The ROM 104 stores programs and data that are basically fixed and not changed of the calculation parameters used by the CPU 102 when performing the numerical calculation and information processing, the device control and the like. The RAM 106 stores programs and data that basically appropriately change in various types of processing of the calculation parameters used by the CPU 102 when performing the numerical calculation and information processing, the device control and the like.

The internal bus 108 is a path for when exchanging data in the information processing apparatus 100. The CPU 102, the ROM 104, and the RAM 106 are connected to each other by the internal bus 108. The internal bus 108 is also connected to the input/output interface 110, and provides the signal corresponding to the command input from the input unit 114 transmitted through the input/output interface 110 and the signal transmitted from other devices connected by network with the information processing apparatus 100 through the network interface 118 to the CPU 102.

The input/output interface 110 has an intermediate function in the exchange of input/output of information. The input/output interface 110 is connected to the display unit 112, the input unit 114, the audio output unit 115, the drive 117, the network interface 118, and the external interface 119. The input/output interface 110 is also connected to the internal bus 108, and provides the signal corresponding to the command input from the input unit 114 and the signal transmitted from other devices connected by network with the information processing apparatus 100 through the network interface 118 to the CPU 102 through the internal bus 108.

The display unit 112 displays content input from the input unit 114, and information related to results etc. of performing the numerical calculation and information processing, the device control etc. in the CPU 102. The display unit 112 may be a liquid crystal display device, an organic EL display device, and the like.

The input unit 114 is operated by the user of the information processing apparatus 100 when inputting various types of commands to the CPU 102. The input unit 114 may be a button, a keyboard, a mouse, a touch pad, and the like.

The audio output unit 115 outputs audio generated in the process when a process involving output of audio is executed in the information processing apparatus 100. The HDD 116 interiorly includes a hard disc, and drives the hard disc to record/reproduce programs read out and executed by the CPU 102 and information (e.g., audio file, moving image file, etc.). The drive 117 is attached with a recording medium that can be carried around, and enables exchange of data between the attached recording medium and the information processing apparatus 100. The recording medium that can be carried around may be a magnetic disc, an optical disc, a magnetic optical disc, a semiconductor memory, or the like, and the drive 117 can use a device capable of reading such recording medium.

The network interface 118 performs exchange of information by wire or wirelessly with another device such as the portable terminal 200 connected with the information processing apparatus 100 by network. The external interface 119 has an intermediate function in the exchange of information with the peripheral device such as the portable terminal 200 used by being connected to the information processing apparatus 100. The external interface 119 includes USB (Universal Serial Bus) port etc.

The configuration of the information processing apparatus 100 according to one embodiment of the present invention has been described above. Next, a functional configuration of an information processing apparatus 100 according to one embodiment of the present invention will be described.

### [3] Functional Configuration of Information Processing Apparatus

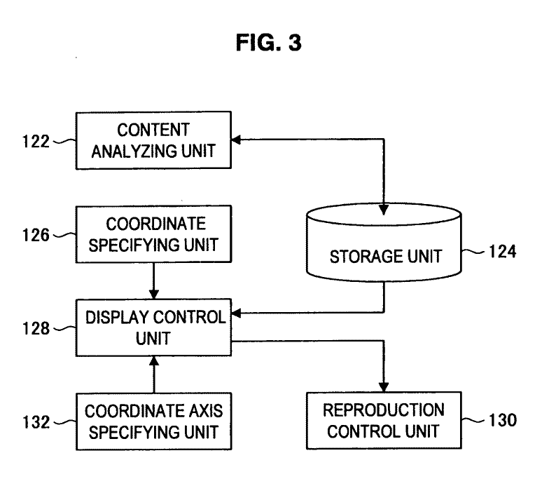

FIG. 3 is an explanatory view describing the functional configuration of the information processing apparatus 100 according to one embodiment of the present invention. The functional configuration of the information processing apparatus 100 according to one embodiment of the present invention will be described below using FIG. 3.

As shown in FIG. 3, the information processing apparatus 100 according to one embodiment of the present invention is configured to include a content analyzing unit 122, a storage unit 124, a coordinate specifying unit 126, a display control unit 128, a reproduction control unit 130, and a coordinate axis specifying unit 132 using FIG. 3.

The content analyzing unit 122 executes the analysis of the content stored in the storage unit 124, to be hereinafter described. The analysis of the content in the content analyzing unit 122 may be 12 tone analysis of music, and the like. The technique publicized in Japanese Patent Application Laid-Open No. 2005-275068 can be used for the 12 tone analysis of the music. Japanese Patent Application Laid-Open No. 2005-275068 discloses a method of dividing the audio signal to a signal of a plurality of octaves by performing down-sampling on an audio signal divided to a plurality of frequency ranges (e.g., 12 frequency ranges), and analyzing the signal of the divided octave by filtering. Thus, to use the technique publicized in Japanese Patent Application Laid-Open No. 2005-275068 for the content analyzing unit 122, the content analyzing unit 122 may include an octave dividing means for down-sampling the audio signal divided into a plurality of frequency ranges to divide into the signal of a plurality of octaves, and a filtering means for filtering the signal of the divided octave.

The analysis of the content by the content analyzing unit 122 may be performed at timing the content is stored in a predetermined folder, or may be performed on a regular basis at a predetermined interval.

The storage unit 124 stores content and various types of information related to the content. The various types of information related to the content include metadata of title of the content, artist name, album name, name of song writer, and play time, and image of the jacket of the content. The storage unit 124 also stores the analysis result of the content in the content analyzing unit 122 in correspondence with the content. The storage unit 124 may be arranged in the HDD 116 in the configuration of the information processing apparatus 100.

The coordinate specifying unit 126 specifies an element of a predetermined coordinate axis in a two-dimensional coordinate system or a three-dimensional coordinate system in an image displayed on the display unit 112 by the operation of the input unit 114 of the user. For the predetermined coordinate axis in the two-dimensional coordinate system or the three-dimensional coordinate system, metadata related to the analysis result of the content, and data such as time/era etc. the content is generated may be used. For example, the coordinate specifying unit 126 can specify, for the coordinate axis, song rhythm, tempo of the song, noisiness of the song, and the like. The content of the content can be represented with the two-dimensional coordinate system or the three-dimensional coordinate system by specifying the element of the coordinate axis in the coordinate specifying unit 126. The details of the image displayed on the display unit 112 will be hereinafter described in detail.

The display control unit 128 controls the display of images to the display unit 112. In the image displayed on the display unit 112, the position of each content stored in the storage unit 124 in the two-dimensional coordinate system or the three-dimensional coordinate system is determined based on the analysis result of the content stored in the storage unit 124. The display control unit 128 determines the image to display on the display unit 112 based on the various types of information related to the content stored in the storage unit 124, and the element of the coordinate axis specified by the coordinate specifying unit 126.

The reproduction control unit 130 controls the reproduction of the content stored in the storage unit 124. For instance, the reproduction control unit 130 reproduces the content when the content is selected from the image of the two-dimensional coordinate system or the three-dimensional coordinate system displayed on the display unit 112, and the reproduction of the content is instructed by the operation of the input unit 114 of the user. The content which reproduction is started by the reproduction control unit 130 is output from the display unit 112 and the audio output unit 115.

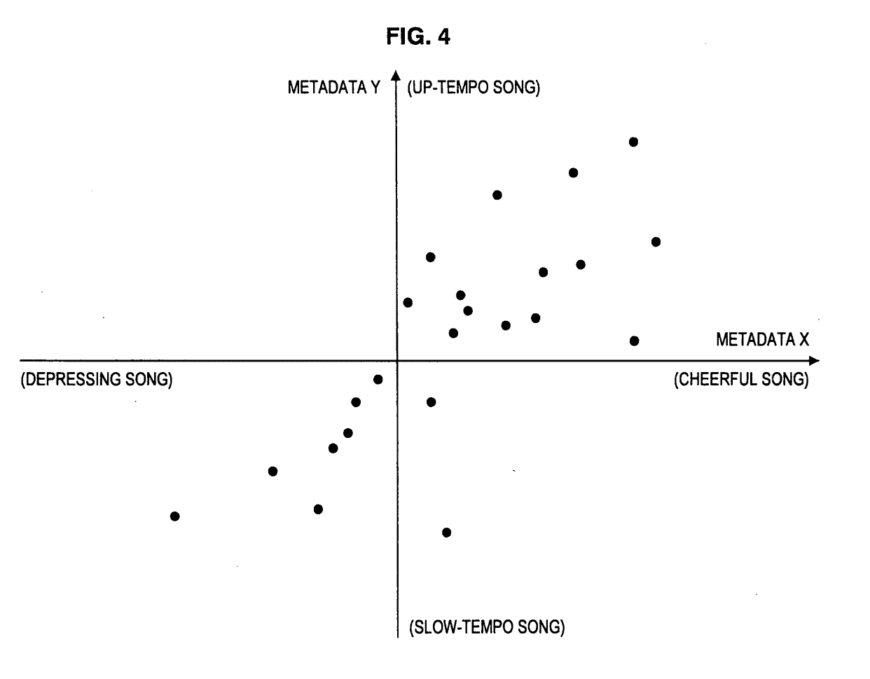

FIGS. 4 to 7 are explanatory views describing an example of the image displayed on the display unit 112 by the display control unit 128. The image displayed on the display unit 112 by the display control unit 128 will be described using FIGS. 4 to 7.

FIG. 4 is an explanatory view showing an example of when each content stored in the storage unit 124 is represented with the two-dimensional coordinate system. In FIG. 4, the X-axis (metadata X) is the cheerful/depressing of the song (positive direction in the X-axis for cheerful song, negative direction in the X-axis for the depressing song), and the Y-axis (metadata Y) is the tempo (positive direction in the Y-axis for up-tempo song, negative direction in the Y-axis for the slow-tempo song). The display control unit 128 arranges each content stored in the storage unit 124 on the two-dimensional coordinate system according to such coordinate axes and the analysis result of the content stored in the storage unit 124.

It can be recognized that the elements of the X-axis and the Y-axis that can be specified are not limited to the example shown in FIG. 4. For instance, the elements of the X-axis and the Y-axis may be loud song-quiet song, acoustic song-electric song, ballad song-rock song, new song-old song, and the like. The elements of the X-axis and the Y-axis may be specified by the coordinate axis specifying unit 132. The elements of the X-axis and the Y-axis by the coordinate axis specifying unit 132 can be arbitrarily specified by the user, where the element of each coordinate axis is specified by the operation of the input unit 114 of the user.

In the example shown in FIG. 4, each content is displayed with a circle in the two-dimensional coordinate system. For instance, when a cursor (not shown) is placed on each circle in the image displayed as in FIG. 4 by the operation of the input unit 114 of the user, the display control unit 128 may display the information of the content corresponding to the relevant point near the cursor, or the display format may be a pop-up format. The information of the content to be displayed in this case may be title of the content, album name recorded with the content, the artist name of the content, the reproduction time of the content, and the like. When click, double click, or the like is performed by the operation of the input unit 114 of the user with respect to each circle in the image displayed as in FIG. 4, the reproduction control unit 130 may reproduce the content corresponding to the relevant point.

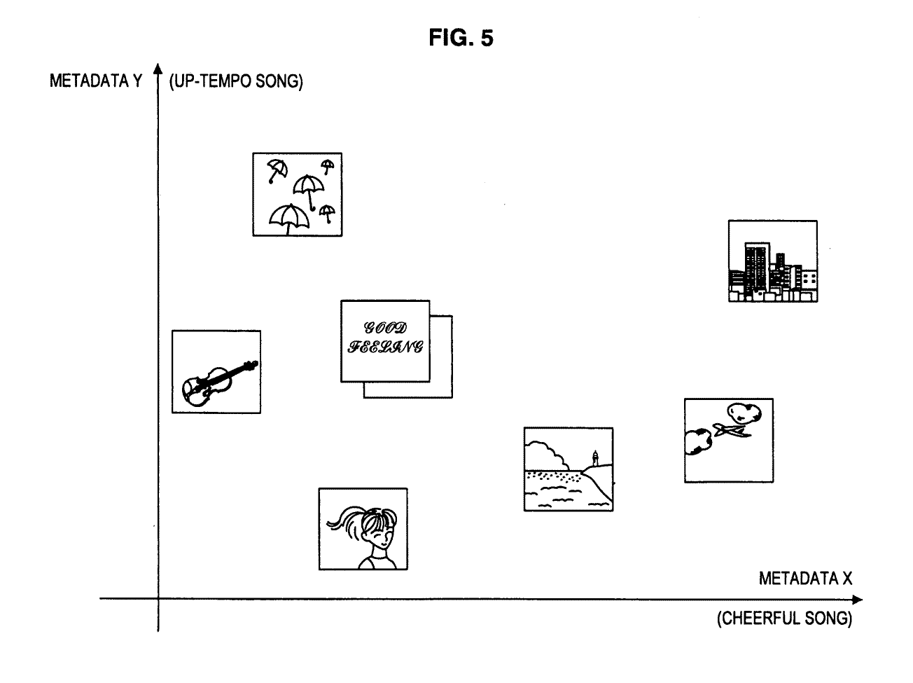

The image of the two-dimensional coordinate system shown in FIG. 4 may be arbitrarily enlarged/reduced by the operation of the input unit 114 of the user. FIG. 5 is an explanatory view showing one example of when part of the image as shown in FIG. 4 is enlarging displayed. The image of the two-dimensional coordinate system shown in FIG. 4 is enlarging/reducing displayed according to the operation of the input unit 114 of the user. When the image represented with the two-dimensional coordinate system is enlarged to greater than or equal to a predetermined magnification, as shown in FIG. 5, the image corresponding to each content is changed from a point to a jacket image by the display control unit 128. The position of each content can be easily grasped by enlarging the image represented with the two-dimensional coordinate system.

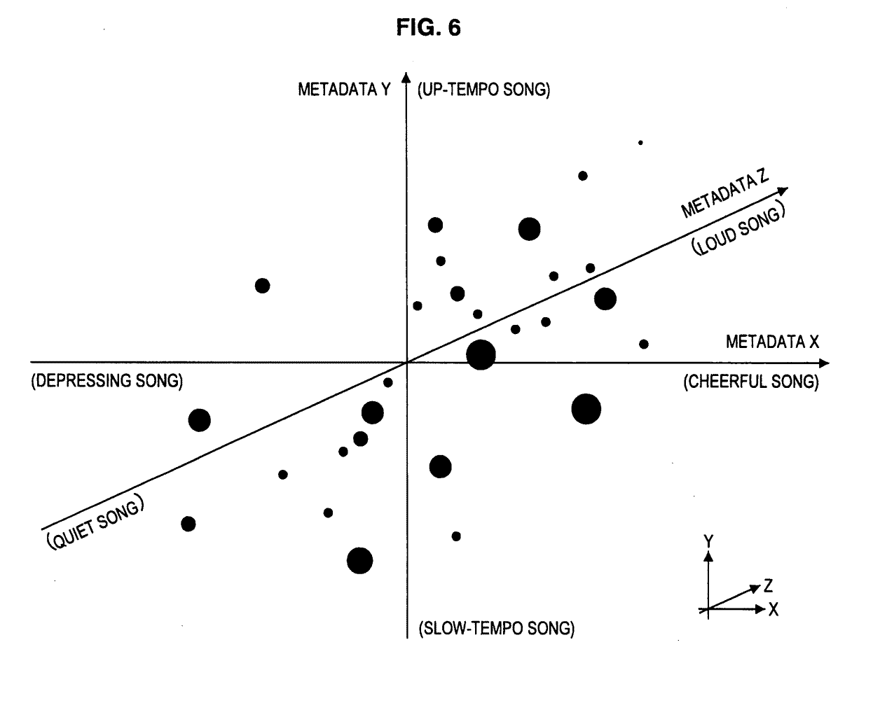

In the above-described example, the arrangement of the content is represented with the two-dimensional coordinate system, but the position of the content can be represented not only with the two-dimensional coordinate system but also with the three-dimensional coordinate system pseudo-representing a three-dimensional space on the plane by increasing the number of coordinate axes. FIG. 6 is an explanatory view showing one example of when each content stored in the storage unit 124 is represented with the three-dimensional coordinate system pseudo-representing a three-dimensional space on the plane.

In the three-dimensional coordinate system shown in FIG. 6, the X-axis (metadata X) is the cheerful/depressing of the song (positive direction in the X-axis for cheerful song, negative direction in the X-axis for the depressing song), the Y-axis (metadata Y) is the tempo (positive direction in the Y-axis for up-tempo song, negative direction in the Y-axis for the slow-tempo song), and the Z-axis is a song rhythm (positive direction in the Z-axis for the loud song, negative direction in the Z-axis for the quiet song). The display control unit 128 arranges each content stored in the storage unit 124 on the three-dimensional coordinate system according to such coordinate axes.

It can be recognized that the elements of the X-axis, the Y-axis and the Z-axis that can be specified are not limited to the example shown in FIG. 6. For instance, the elements of the X-axis, the Y-axis and the Z-axis may be acoustic song-electric song, ballad song-rock song, new song-old song, and the like. The elements of the X-axis, the Y-axis and the Z-axis may be specified by the coordinate axis specifying unit 132. The specification of the elements of the X-axis, the Y-axis and the Z-axis by the coordinate axis specifying unit 132 can be performed by the operation of the input unit 114 of the user.

In the example shown in FIG. 6, each content is displayed with a circle in the three-dimension coordinate system. When the cursor is placed on each circle in the image displayed as in FIG. 6 by the operation of the input unit 114 of the user, the display control unit 128 may display the information of the content corresponding to the relevant point near the cursor, or the display format may be a pop-up format. When click operation, double click operation, or the like is performed by the operation of the input unit 114 of the user with respect to each circle in the image displayed as in FIG. 6, the reproduction control unit 130 may reproduce the content corresponding to the relevant point.

In the example shown in FIG. 6, the arrangement in the three-dimensional coordinate system is expressed with small and large of the size of the circle. In other words, the content is positioned on the near side (negative direction of Z-axis) according to the larger circle, and the content is positioned on the far side (positive direction of Z-axis) according to the smaller circle.

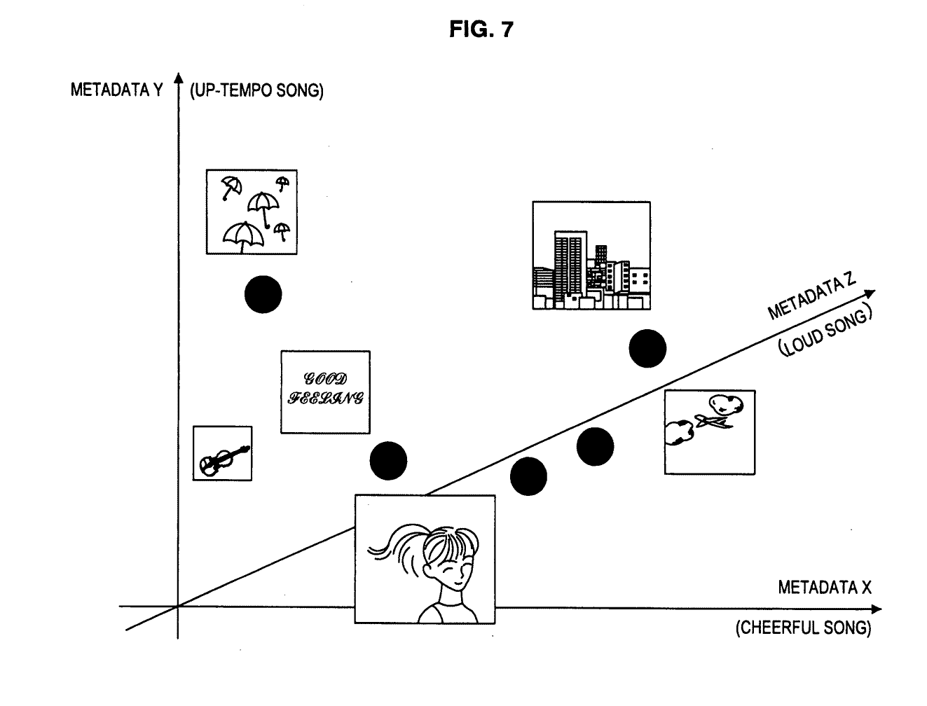

The image of the three-dimensional coordinate system shown in FIG. 6 may be arbitrarily enlarged/reduced by the operation of the input unit 114 of the user. FIG. 7 is an explanatory view showing one example of when part of the image as shown in FIG. 6 is enlarging displayed. The image of the three-dimensional coordinate system shown in FIG. 6 is enlarging/reducing displayed according to the operation of the input unit 114 of the user. When the image represented with the three-dimensional coordinate system is enlarged to greater than or equal to a predetermined magnification, as shown in FIG. 7, the image corresponding to each content is changed from a point to a jacket image by the display control unit 128. The position of each content can be easily grasped by enlarging the image represented with the three-dimensional coordinate system.

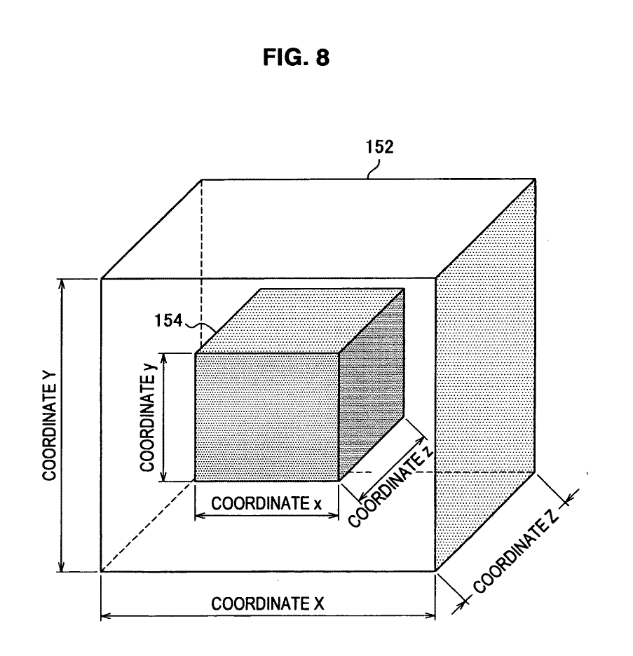

One example of a range of displaying the jacket image of the content will be described with the three-dimensional coordinate system as shown in FIGS. 6 and 7, by way of example. FIG. 8 is an explanatory view describing the display control of the jacket image displayed on the display unit 112 of the information processing apparatus 100 according to one embodiment of the present invention. The range of displaying the jacket image of the content will be described using FIG. 8.

In FIG. 8, the range surrounded by a cube on the outer side represented by reference numeral 152 shows the three-dimensional space of the range where the entire content stored in the storage unit 124 can be arranged, and corresponds to the range of the image displayed by the display control unit 128 at the beginning. The range surrounded by a cube on the inner side represented by reference numeral 154 shows the three-dimensional space of the range for displaying the jacket image of the content.

When enlarging displayed by the operation of the input unit 114 of the user, the value of a coordinate (x, y) of a plane including the X-axis and the Y-axis is determined. When the values of x, y become a predetermined value, the content is displayed with a jacket photo in the range of the cube represented by reference numeral 154. Regarding the contents not in the range of the cube represented by reference numeral 154, the content is not displayed with the jacket photo, and is easy displayed with a general-purpose object (circle in the example shown in FIGS. 4 to 7).

The easy display of the content information by the three-dimensional coordinate system pseudo-expressing the three-dimensional space on the plane becomes possible by displaying the image corresponding to the content on the display unit 112 of the information processing apparatus 100.

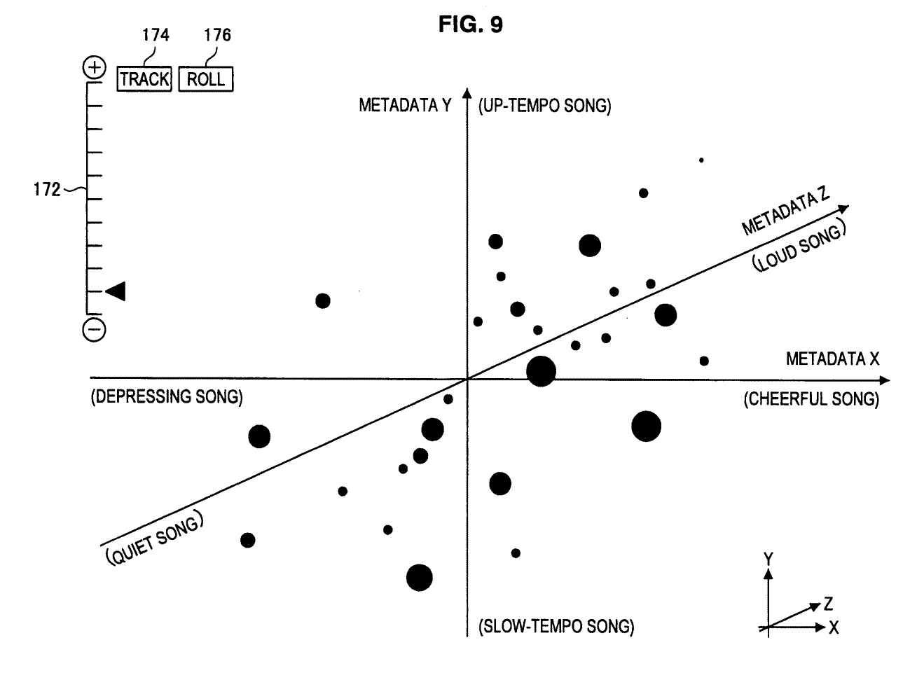

The image of the three-dimensional space system displayed by the display control unit 128 shown in FIGS. 6 and 7 may be rotated by the operation of the user. FIG. 9 is an explanatory view showing a case of rotating the image of the three-dimensional space system by the operation of the user by displaying a slide bar for executing the enlargement/reduction process and a button for executing a track/roll process. FIG. 9 shows one example of when a slide bar 172, a track button 174, and a roll button 176 are superimposed and displayed on the image of the three-dimensional space system.

For instance, when the slide bar 172 is operated by the operation of the input unit 114 of the user, the display control unit 128 executes the enlargement and reduction process of the image. When the track button 174 is pressed by the operation of the input unit 114 of the user, the display control unit 128 rotates the image with an arbitrary axis as the center according to the operation of the input unit 114 of the user. When the roll button 176 is pressed by the operation of the input unit 114 of the user, the display control unit 128 rotates the image with the Z-axis as the center according to the operation of the input unit 114 of the user.

The track button 174 and the roll button 176 may function as a toggle. In other words, the operation of the track button 174 and the roll button 176 may be controlled such that the respective functions are validated when the track button 174 and the roll button 176 are pressed once, and the respective functions are invalidated when pressed again.

In the present invention, the track/roll process may be executed by the operation of the input unit 114 of the user other than by the control by the graphical user interface. For instance, when the user performs the operation with a mouse, the user may place the mouse cursor on a coordinate screen, and control enlargement/reduction of the image with the track ball. The user may place the mouse cursor on the coordinate screen and perform the track process by moving the mouse up and down, left and right while pressing the left button. Furthermore, the user may place the mouse cursor on the coordinate screen and perform the roll process by moving the mouse up and down, left and right while pressing the right button. It can be recognized that the control by the graphical user interface and the control by the operation of the input unit 114 may be simultaneously used.

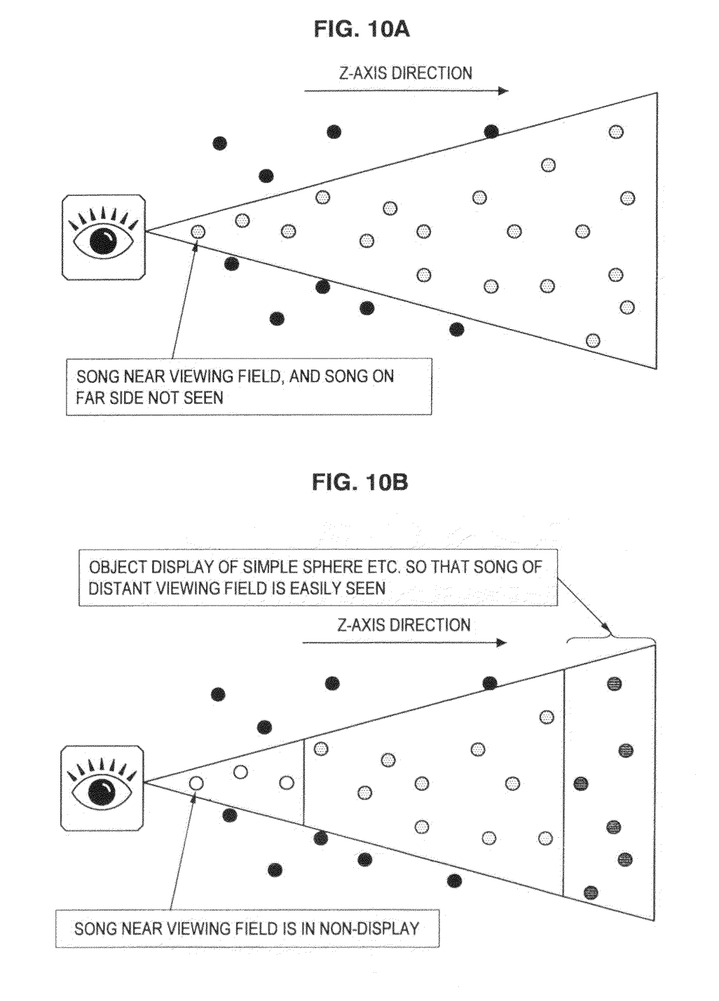

In the image of the three-dimensional space system displayed by the display control unit 128 shown in FIGS. 6 and 7, the display control unit 128 may perform a control such that the jacket image corresponding to the content is not displayed near the coordinate corresponding to the view point. FIGS. 10A and 10B are explanatory views showing an overview of a case of controlling the jacket image corresponding to the content to be in non-display near the coordinate corresponding to the view point.

As shown in FIG. 10A, when all the content are displayed in the jacket image in the three-dimensional coordinate system, the jacket image positioned near the coordinate corresponding to the view point is also enlarged when the enlargement display is carried out. The jacket image comes in the way if enlarged when searching for the content, and the content becomes difficult to search.

Therefore, as shown in FIG. 10B, the display control unit 128 performs a control so as not to display the jacket image positioned near the view point. The search of the content is facilitated by having the display control unit 128 perform the control to not display the jacket image positioned near the view point.

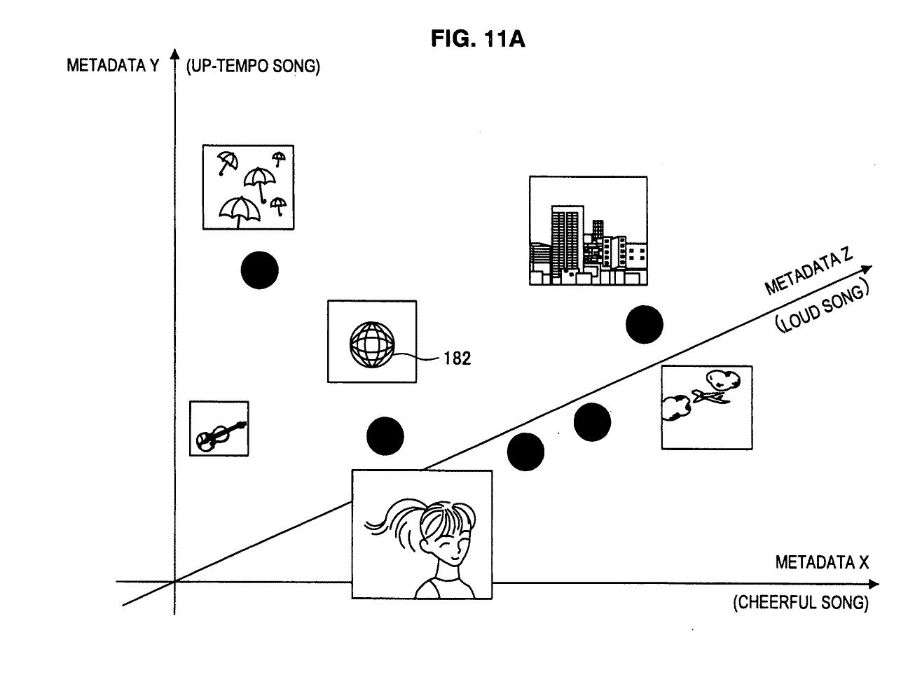

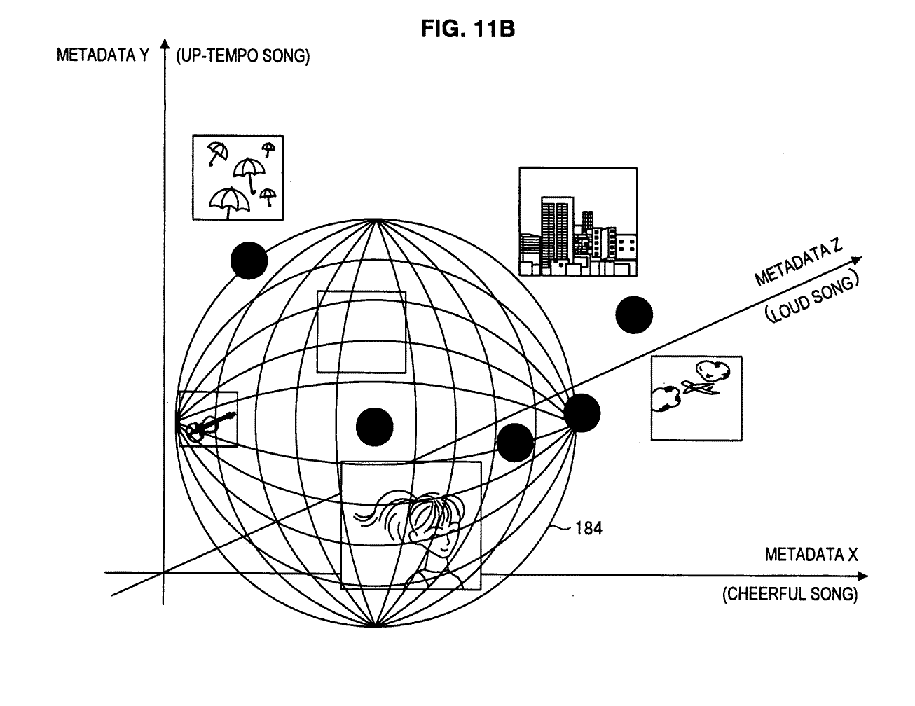

In the image of the three-dimensional space system displayed on the display unit 112 by the display control unit 128 shown in FIGS. 6 and 7, an object appearing in spherical shape is displayed by the display control unit 128, so that the content can be selected by the spherical object. FIGS. 11A and 11B are explanatory views for when selecting the content by an object appearing in spherical shape.

In FIG. 11A, a case in which one content is selected by the operation of the input unit 114 by the user from the image of the content displayed in the three-dimensional space system by the display control unit 128, and a select cursor 182 represented in a spherical shape is displayed by the display control unit 128. The select cursor 182 may be displayed by the display control unit 128 by placing the cursor on one content and right clicking the mouser.

The size of the sphere of the select cursor may be changed by having the user operate the input unit 114 with the relevant select cursor displayed. FIG. 11B shows one example of a case in which a plurality of contents is selected for the select cursor 184 by enlarging the spherical select cursor 182 shown in FIG. 11A. The content of an atmosphere close to the selected content can be selected in plurals all at once by deforming the size of the sphere and defining the selecting range.

When the reproduction of the content starts with the content selected in plurals, a so-called random reproduction may be performed among the selected contents. If the content is selected in plurals, a playlist including the selected contents may be created.

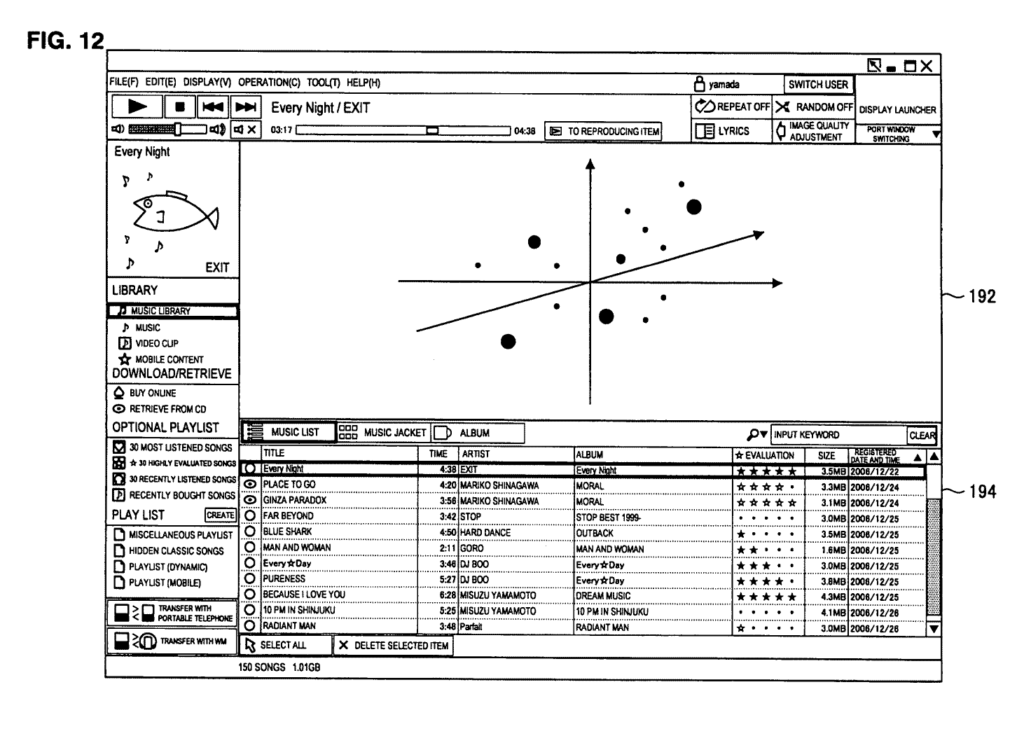

The image of the three-dimensional space system shown in FIGS. 6 and 7 may be used in combination with the juke box program capable of selecting and reproducing the content. FIG. 12 is an explanatory view showing an application example of the image displayed by the display control unit 128 according to one embodiment of the present invention to the juke box program. In FIG. 12, an image 192 of the content arranged in the three-dimensional space system is displayed at the upper stage and the contents stored in the storage unit 124 are displayed in a list (library list 194) at the lower stage.

In the juke box program shown in FIG. 12, when the content is selected with the image 192 of the three-dimensional space system displayed at the upper stage, the content corresponding to the selected content may be set to a selected state in the library list 194 at the lower stage. When the content is selected with the library list 194, the object corresponding to the selected content may be set to a selected state in the image 192 of the three-dimensional space system displayed at the upper stage.

As shown in FIG. 12, the image of the three-dimensional system shown in FIGS. 6 and 7 may be reproduced, transferred to the portable terminal 200 or utilized to search for the content by being displayed by the juke box program. For instance, the contents of similar atmosphere can be easily selected by using the juke box program as shown in FIG. 12 when selecting the contents of similar atmosphere and transferring to the portable terminal 200.

### [4] Summary

According to one embodiment of the present invention described above, the jacket image of the content can be displayed in the two-dimensional coordinate system or the three-dimensional coordinate system using the analysis result of the content stored in the information processing apparatus 100. Thus, the content of the content stored inside the information processing apparatus 100 can be visually presented to the user by displaying the jacket image of the content in the two-dimensional coordinate system or the three-dimensional coordinate system. A new discovery can be provided to the user by arranging the contents having similar characteristics together.

The operation of the information processing apparatus 100 described above may be carried out by storing the computer program in the interior (e.g., HDD 116) of the information processing apparatus 100, and reading out and sequentially executing the relevant computer program with the CPU 102.

It should be understood by those skilled in the art that various modifications, combinations, sub-combinations and alterations may occur depending on design requirements and other factors insofar as they are within the scope of the appended claims or the equivalents thereof.

For instance, the content analyzing unit 122 is arranged in the information processing apparatus 100 in the above-described embodiment, but the present invention is not limited to such example. The content of the content may be analyzed in advance with a device other than the information processing apparatus 100, and the analysis result of the content may be received by the information processing apparatus 100 and stored in the storage unit 124.

The present application contains subject matter related to that disclosed in Japanese Priority Patent Application JP 2008-291937 filed in the Japan Patent Office on 14 Nov. 2008, the entire content of which is hereby incorporated by reference.

What is claimed is:

1. An information processing apparatus, comprising:
a storage unit for storing content identification information for identifying a content, content analysis result corresponding to the content identification information and being obtained by analyzing the content, and a first image corresponding to the content identification information;
a coordinate specifying unit for specifying a predetermined coordinate in a three-dimensional coordinate system; and
a display control unit for arranging the first image corresponding to the content identification information or a second image different from the first image on the three-dimensional coordinate system based on the content analysis result stored in the storage unit, and displaying the first image and/or the second image according to a distance with a coordinate corresponding to the content identification information based on the predetermined coordinate specified by the coordinate specifying unit and the content analysis result.

2. The information processing apparatus according to claim 1, wherein the display control unit displays information of a content contained in the content identification information when the first image or the second image is selected by the operation input.

3. The information processing apparatus according to claim 1, further comprising a content reproduction unit for reproducing content corresponding to the first image or the second image when the first image or the second image is selected by the operation input.

4. The information processing apparatus according to claim 1, wherein the display control unit does not display the first image for the content positioned at less than a predetermined distance from the predetermined coordinate specified by the coordinate specifying unit.

5. The information processing apparatus according to claim 1, wherein the display control unit displays the second image from a point spaced apart by greater than or equal to a predetermined distance from the predetermined coordinate specified by the coordinate specifying unit.

6. The information processing apparatus according to claim 1, wherein the display control unit displays while changing the size of the first image and the second image according to a distance on the three-dimensional coordinate system from a predetermined position.

7. The information processing apparatus according to claim 1, wherein when the operation input is a process of rotating the three-dimensional coordinate system, the display control unit changes display of the first image and the second image according to the process.

8. The information processing apparatus according to claim 1, wherein when the operation input is a process of enlarging or reducing with respect to the display of the three-dimensional coordinate system, the display control unit changes display of the first image and the second image according to the process.

9. The information processing apparatus according to claim 1, further comprising:
a coordinate axis specifying unit for specifying a coordinate axis of the three-dimensional coordinate system with an arbitrary content analysis result, wherein
the display control unit displays the first image and/or the second image based on a coordinate axis specified by the coordinate axis specifying unit.

10. The information processing apparatus according to claim 1, further comprising a content selecting unit for selecting one or more contents by including the first image and the second image inside a sphere formed by specifying an arbitrary radius with an arbitrary position as a center.

11. An image display method, comprising the steps of:
storing content identification information for identifying a content, content analysis result corresponding to the content identification information and being obtained by analyzing the content, and a first image corresponding to the content identification information;
specifying a predetermined coordinate in a three-dimensional coordinate system; and
arranging the first image corresponding to the content identification information or a second image different from the first image on the three-dimensional coordinate system based on the content analysis result stored in the storing means, and displaying the first image and/or the second image according to a distance with a coordinate corresponding to the content identification information based on the predetermined coordinate specified by the coordinate specifying unit and the content analysis result.

12. A computer program for causing a computer to execute the steps of:
storing content identification information for identifying a content, content analysis result corresponding to the content identification information and being obtained by analyzing the content, and a first image corresponding to the content identification information;
specifying a predetermined coordinate in a three-dimensional coordinate system; and
arranging the first image corresponding to the content identification information or a second image different from the first image on the three-dimensional coordinate system based on the content analysis result stored in the storing means, and displaying the first image and/or the second image according to a distance with a coordinate corresponding to the content identification information based on the predetermined coordinate specified by the coordinate specifying unit and the content analysis result.
